(19) United States
(12) Patent Application Publication
(10) Pub. No.: US 2019/0096143 A1
(43) Pub. Date: Mar. 28, 2019

(54) SUPPRESSING TRANSMISSION OF DATA FROM POSITION REPORTING BEACONS USING GEOGRAPHIC LOCATION

(71) Applicant: L3 Technologies, Inc., New York, NY (US)

(72) Inventors: Michael E. Weed, Nokomis, FL (US); William N. Waggener, JR., Sarasota, FL (US)

(73) Assignee: L3 Technologies, Inc., New York, NY (US)

(21) Appl. No.: 15/719,189

(22) Filed: Sep. 28, 2017

(51) Int. Cl. G07C 5/00; G01S 19/42

(52) U.S. Cl. CPC G07C 5/008; G01S 19/42

(57) ABSTRACT

Various communication systems may benefit from the appropriate suppression of unnecessary transmissions. For example, certain position reporting systems may benefit from suppressing transmission of data from position reporting beacons using geographic location. A method can include determining a current position of a vehicle. The method can also include comparing the current position of the vehicle to a position-reporting mask. The method can further include reporting the position of the vehicle conditionally based on the comparison to the mask.

### BACKGROUND

### Field

Various communication systems may benefit from the appropriate suppression of unnecessary transmissions. For example, certain position reporting systems may benefit from suppressing transmission of data from position reporting beacons using geographic location.

### Description of the Related Art

Position reporting beacons provide one possible element of safety for vehicles, such as aircraft. In particular, position reporting beacons can serve to supplement surveillance of aircraft, particularly in areas where ground-based radar systems are unable to constantly observe aircraft.

Nevertheless, the use of position reporting beacons consumes data bandwidth and can provide a burden on the position-monitoring infrastructure when the position reports are provided unnecessarily.

### SUMMARY

According to certain embodiments of the present invention, a method can include determining a current position of a vehicle. The method can also include comparing the current position of the vehicle to a position-reporting mask. The method can further include reporting the position of the vehicle conditionally based on the comparison to the mask.

In certain embodiments of the present invention, an apparatus can include at least one processor and at least one memory including computer program code. The at least one memory and the computer program code can be configured to, with the least one processor, cause the apparatus at least to determine a current position of a vehicle. The at least one memory and the computer program code can also be configured to, with the least one processor, cause the apparatus at least to compare the current position of the vehicle to a position-reporting mask. The at least one memory and the computer program code can further be configured to, with the least one processor, cause the apparatus at least to report the position of the vehicle conditionally based on the comparison to the mask.

An apparatus, according to certain embodiments of the present invention, can include means for determining a current position of a vehicle. The apparatus can also include means for comparing the current position of the vehicle to a position-reporting mask. The apparatus can further include means for reporting the position of the vehicle conditionally based on the comparison to the mask.

A non-transitory computer-readable medium can, in certain embodiments of the present invention, be encoded with instructions that, when executed in hardware, perform a process. The process can include determining a current position of a vehicle. The process can also include comparing the current position of the vehicle to a position-reporting mask. The process can further include reporting the position of the vehicle conditionally based on the comparison to the mask.

### BRIEF DESCRIPTION OF THE DRAWINGS

For proper understanding of the invention, reference should be made to the accompanying drawings, wherein:

FIG. 1 illustrates an exemplary method, according to certain embodiments of the present invention.

FIG. 2 illustrates an exemplary system, according to certain embodiments of the present invention.

### DETAILED DESCRIPTION

Certain embodiments of the present invention provide for ways to minimize the burden of aircraft beacons that report aircraft position. In particular, certain embodiments provide ways to avoid unnecessarily burdening infrastructure used for receiving, storing and sending received position reports.

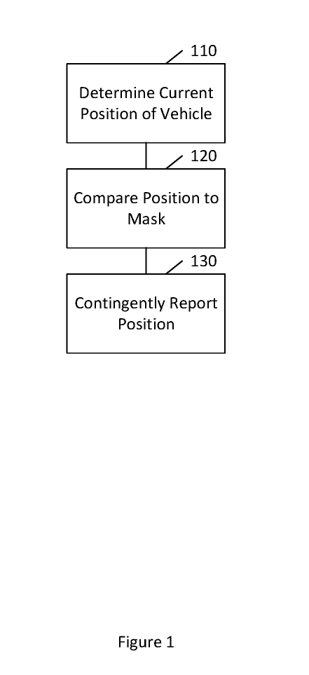

FIG. 1 illustrates an exemplary method, according to certain embodiments of the present invention. As shown in FIG. 1, the method can include, at 110, determining a current position of a vehicle. The vehicle can be an aircraft. For example, the vehicle can be an airplane, a helicopter, an unmanned aerial vehicle, a dirigible, or any other airborne vehicle. The current position can be determined using a global positioning system (GPS) or any other desired system or technique, such as by triangulation from radio beacons.

The method can also include, at 120, comparing the current position of the vehicle to a position-reporting mask. This comparison can be done using any desired technique. For example, the comparing can include determining whether the position of the vehicle is within a reporting permitted area or determining whether the position of the vehicle is within a reporting forbidden area. A reporting permitted area can be an area within which vehicle position reporting is permitted, whereas a reporting forbidden area can be an area within which vehicle position reporting is forbidden. Reporting may, in certain embodiments of the present invention, be mandatory in the reporting permitted areas or in areas where reporting is not forbidden.

In other embodiments of the present invention, the comparing can involve determining a level of reporting for an area corresponding to the position of the vehicle. The level of reporting can be a specific frequency of reporting or as little as no reporting. For example, in certain embodiments of the present invention, the reporting rate may be high in places where there is little or no ground-based surveillance, and the reporting rate may be low in places where there is expected to be active ground-based surveillance of the vehicle.

In certain embodiments of the present invention, the mask can be a static mask that is predefined. Alternatively, however, the mask can be a dynamic mask. The dynamic mask can take into account any recent evidence of ground surveillance or any other desired evidence, whether recent or otherwise. If there is evidence of ground surveillance, such as communications from ground stations or detected primary radar pings, then the mask may completely or partially suppress reporting. If, however, there is no evidence of ground surveillance, then the mask may permit or enhance reporting.

The method can further include, at 130, reporting the position of the vehicle, conditionally based on the comparison to the mask. For example, the reporting may contingently be suppressed when the mask indicates that the vehicle is in a place where reporting should not be done, or should be done less frequently.

The position reporting may rely on, for example, satellite communication to report the position of the vehicle. Thus, a satellite radio link can be used to communicate the position report.

Various implementations are possible. For example, data transmission from a vehicle's position reporting beacon can be suppressed when the beacon is located in an area not requiring position reports. The beacon can incorporate a map database, user-defined mask areas or mask areas defined by any other desired means, indicating areas that do not require position reports. The beacon can compare the current vehicle location with the mask areas in the map database, which may define an initial rendering of position reporting requirements and be updated by user-defined or other mask area updates, to determine if a position report should be transmitted.

Masked areas may, for example, be areas covered by ground based surveillance radar or other tracking methods. Use of masking may reduce data transmission rates, while allowing full position reporting while in areas not covered by other tracking methods. Such uncovered areas may include, for example, ocean areas, polar areas, other wilderness areas or other areas not covered by other tracking methods. Beacons could thus be widely implemented without incurring large data transmission and storage resources.

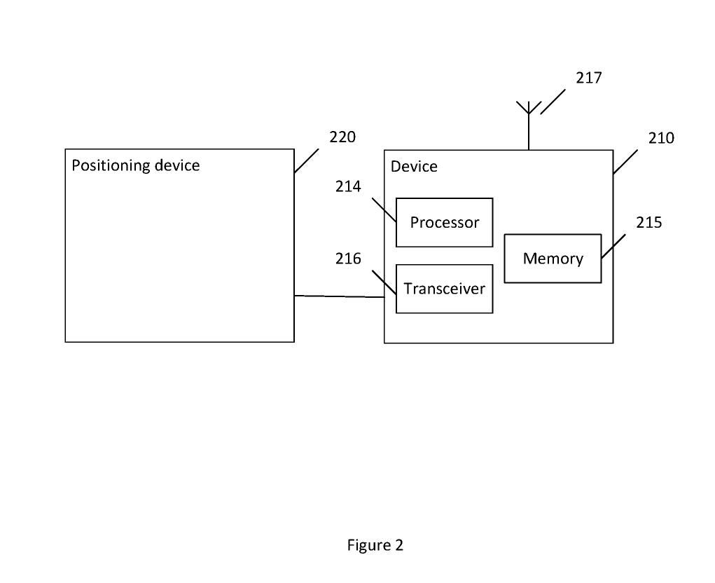

FIG. 2 illustrates an exemplary system, according to certain embodiments of the present invention. It should be understood that each block of the exemplary method of FIG. 1 may be implemented by various means or their combinations, such as hardware, software, firmware, one or more processors and/or circuitry. In one embodiment of the present invention, a system may include several devices, such as, for example, device 210 and positioning device 220. The system may include more than one positioning device 220 and more than one device 210, although only one of each is shown for the purposes of illustration. The device 210 may be any suitable piece of avionics hardware, such as a line replaceable unit of an avionics system. The positioning device 220 may be any desired device for determining the position of a vehicle carrying the system, such as a GPS device, or the like.

The device 210 may include at least one processor or control unit or module, indicated as 214. At least one memory may be provided in the device 210, indicated as 215. The memory 215 may include computer program instructions or computer code contained therein, for example, for carrying out the embodiments of the present invention, as described above. One or more transceivers 216 may be provided, and the device 210 may also include an antenna, illustrated as 217. Although only one antenna is shown, many antennas and multiple antenna elements may be provided for the device 210. Other configurations of the device 210, for example, may be provided. For example, device 210 may also be configured for wired communication (as shown to connect to positioning device 220), in addition to wireless communication, and in such a case, antenna 217 may illustrate any form of communication hardware, without being limited to merely an antenna.

Transceiver 216 may be a transmitter, a receiver, or both a transmitter and a receiver, or a unit or a device that may be configured both for transmission and reception.

Processor 214 may be embodied by any computational or data processing device, such as a central processing unit (CPU), a digital signal processor (DSP), an application specific integrated circuit (ASIC), a programmable logic device (PLD), a field programmable gate array (FPGA), a digitally enhanced circuit, or a comparable device or a combination thereof. The processor 214 may be implemented as a single controller, or a plurality of controllers or processors. Additionally, the processor 214 may be implemented as a pool of processors in a local configuration, in a cloud configuration, or in a combination thereof. The term “circuitry” may refer to one or more electric or electronic circuits. The term “processor” may refer to circuitry, such as logic circuitry, that responds to and processes instructions that drive a computer.

For firmware or software, the implementation may include modules or units of at least one chip set (e.g., procedures, functions, and so on). Memory 215 may be any suitable storage device, such as a non-transitory computer-readable medium. A hard disk drive (HDD), random access memory (RAM), flash memory, or other suitable memory may be used. The memory 215 may be combined on a single integrated circuit as the processor, or may be separate therefrom. Furthermore, the computer program instructions which may be stored in the memory 215 and processed by the processor 214 can be any suitable form of computer program code, for example, a compiled or interpreted computer program written in any suitable programming language. The memory 215 or data storage entity is typically internal but may also be external or a combination thereof, such as in the case when additional memory capacity is obtained from a service provider. The memory may be fixed or removable.

The memory 215 and the computer program instructions may be configured, with the processor 214 for the particular device, to cause a hardware apparatus, such as device 210, to perform any of the processes described above (see, for example, FIG. 1). Therefore, in certain embodiments of the present invention, a non-transitory computer-readable medium may be encoded with computer instructions or one or more computer programs (such as added or updated software routines, applets or macros) that, when executed in hardware, may perform a process, such as one or more of the processes described herein. Computer programs may be coded by any programming language, which may be a high-level programming language, such as objective-C, C, C++, C#, Java, etc., or a low-level programming language, such as a machine language, or an assembler. Alternatively, certain embodiments of the present invention may be performed entirely in hardware.

One having ordinary skill in the art will readily understand that the invention as discussed above may be practiced with steps in a different order, and/or with hardware elements in configurations which are different than those which are disclosed. Therefore, although the invention has been described based upon these disclosed embodiments, it would be apparent to those of skill in the art that certain modifications, variations, and alternative constructions would be apparent, while remaining within the spirit and scope of the invention.

We claim:

1. A method, comprising:
determining a current position of a vehicle;
comparing the current position of the vehicle to a position-reporting mask; and
reporting the position of the vehicle conditionally based on the comparison to the mask.

2. The method of claim 1, wherein the vehicle comprises an aircraft.

3. The method of claim 1, wherein the current position of the vehicle is determined using a global positioning system.

4. The method of claim 1, wherein the comparing comprises determining whether the position of the vehicle is within an area within which vehicle position reporting is permitted.

5. The method of claim 1, wherein the comparing comprises determining whether the position of the vehicle is within an area within which vehicle position reporting is forbidden.

6. The method of claim 1, wherein the comparing comprises determining a level of reporting for an area corresponding to the position of the vehicle.

7. The method of claim 1, wherein the mask comprises a dynamic mask.

8. The method of claim 1, wherein the reporting comprises communicating using a satellite radio link.

9. An apparatus, comprising:
at least one processor; and
at least one memory including computer program code;
wherein the at least one memory and the computer program code are configured to, with the least one processor, cause the apparatus at least to:
determine a current position of a vehicle;
compare the current position of the vehicle to a position-reporting mask; and
report the position of the vehicle conditionally based on the comparison to the mask.

10. The apparatus of claim 9, wherein the vehicle comprises an aircraft.

11. The apparatus of claim 9, wherein the current position of the vehicle is determined using a global positioning system.

12. The apparatus of claim 9, wherein the comparing comprises determining whether the position of the vehicle is within an area within which vehicle position reporting is permitted.

13. The apparatus of claim 9, wherein the comparing comprises determining whether the position of the vehicle is within an area within which vehicle position reporting is forbidden.

14. The apparatus of claim 9, wherein the comparing comprises determining a level of reporting for an area corresponding to the position of the vehicle.

15. The apparatus of claim 9, wherein the mask comprises a dynamic mask.

16. The apparatus of claim 9, wherein the reporting comprises communicating using a satellite radio link.

17. A non-transitory computer-readable medium encoded with instructions that, when executed in hardware, perform a process, the process comprising:
determining a current position of a vehicle;
comparing the current position of the vehicle to a position-reporting mask; and
reporting the position of the vehicle conditionally based on the comparison to the mask.

18. The method of claim 17, wherein the comparing comprises determining whether the position of the vehicle is within an area within which vehicle position reporting is permitted.

19. The method of claim 17, wherein the comparing comprises determining whether the position of the vehicle is within an area within which vehicle position reporting is forbidden.

20. The method of claim 17, wherein the comparing comprises determining a level of reporting for an area corresponding to the position of the vehicle.
